(19) United States
(12) Patent Application Publication
(10) Pub. No.: US 2020/0290310 A1
(43) Pub. Date: Sep. 17, 2020

(54) LIGHTWEIGHT REINFORCED THERMOPLASTIC COMPOSITE ARTICLES INCLUDING BICOMPONENT FIBERS

(71) Applicants: Ruomiao Wang, Forest, VA (US); Hongyu Chen, Forest, VA (US)

(72) Inventors: Ruomiao Wang, Forest, VA (US); Hongyu Chen, Forest, VA (US)

(21) Appl. No.: 16/778,097

(22) Filed: Jan. 31, 2020

Related U.S. Application Data
(60) Provisional application No. 62/800,314, filed on Feb. 1, 2019.
(60) Provisional application No. 62/874,306, filed on Jul. 15, 2019.

(51) Int. Cl. B32B 5/10; B32B 7/12; B32B 5/02; B32B 5/08; B32B 5/26; B32B 27/12; B29C 70/50; B60R 13/02; E04B 2/74; A47B 96/20

(52) U.S. Cl. CPC B32B 5/10; B29K 2309/08; B32B 5/022; B32B 5/08; B32B 5/26; B32B 27/12; B29C 70/50; B60R 13/0212; E04B 2/74; A47B 96/206; B32B 2262/12; B32B 2262/0253; B32B 2262/0261; B32B 2262/0276; B32B 2262/0284; B32B 2262/14; B32B 2262/101; B32B 2307/546; B32B 2479/00; B32B 2605/003; B32B 2607/00; B32B 7/12

(57) ABSTRACT

Lightweight reinforced thermoplastic articles with a core layer including bicomponent fibers in the core layer are described. In some examples, the core layer includes a thermoplastic material, reinforcing fibers, bicomponent fibers and a lofting agent. After molding of the composite article, an improvement in one or more of peak load values, stiffness values, flexural strength values and flexural modulus values can be achieved for a particular molding thickness.

### PRIORITY APPLICATION

This application is related to, and claims priority to and the benefit of, U.S. Provisional Application No. 62/800,314 filed on Feb. 1, 2019 and U.S. Provisional Application No. 62/874,036 filed on Jul. 15, 2019, the entire disclosure of each of which is hereby incorporated herein by reference.

### TECHNOLOGICAL FIELD

Certain embodiments are directed to thermoplastic composite articles comprising bicomponent fibers. In some instances, the thermoplastic composite articles with the bicomponent fibers may provide improved performance over thermoplastic composite articles lacking the bicomponent fibers.

### BACKGROUND

Certain automotive and building applications often use thermoplastic based materials in place of conventional steel or metal articles. The use of thermoplastic based materials can create unique considerations not encountered with steel or metal articles.

### SUMMARY

Certain aspects are described herein to illustrate some configurations of thermoplastic composite articles with bicomponent fibers. It will be within the ability of the person having ordinary skill in the art, given the benefit of this disclosure, to produce other configurations of thermoplastic composite articles that include bicomponent fibers.

In an aspect, a molded porous composite article comprises a lofted core layer comprising a web formed from reinforcing fibers, bicomponent fibers, a lofting agent and a thermoplastic material, wherein the web comprises a porosity of about 20% to about 80%, and wherein the bicomponent fibers comprise a core-shell arrangement, wherein a shell material of the shell of the core-shell arrangement comprises a melting point that is substantially similar to a melting point of the thermoplastic material, and wherein a core material of the core of the core-shell arrangement comprises a melting point that is at least twenty degrees Celsius higher than the melting point of the thermoplastic material, and wherein the molded porous composite article comprises a peak load of 10 N to about 40 N in the machine direction and a peak load of about 6N to about 30N in the cross direction at a molded thickness of about 2 mm to about 4 mm in both the machine and cross directions as tested by SAE J949_200904.

In certain embodiments, the bicomponent fibers comprise a shell comprising a polyolefin and a core comprising a polyester or a polyamide. In other examples, the bicomponent fibers comprise a shell comprising a polyolefin and a core comprising a polyester. In some examples, the polyolefin comprises a polyethylene. In other examples, the polyethylene is linear low density polyethylene. In some embodiments, the polyester comprises polyethylene terephthalate. In other examples, the polyamide comprises nylon.

In some instances, the thermoplastic material is polypropylene, the polyolefin of the shell comprises linear low density polyethylene, the lofting agent comprises expandable microspheres and the polyester of the core comprises polyethylene terephthalate.

In other instances, the thermoplastic material is polypropylene, the polyolefin of the shell comprises linear low density polyethylene, the lofting agent comprises expandable microspheres and the polyamide of the core comprises nylon.

In certain examples, the thermoplastic material comprises polypropylene, the reinforcing fibers comprise glass fibers, the bicomponent fibers comprise a linear low density polyethylene in the shell and a polyester or polyamide in the core, wherein a melting point of the polyester or polyamide in the core is at least twenty degrees Celsius higher than a melting point of the thermoplastic material, wherein the lofting agent comprises expandable microspheres.

In some examples, the molded composite article further comprises a stiffness in the machine direction of about 10 N/cm to about 50 N/cm and a stiffness in the cross direction of about 7 N/cm to about 30 N/cm as tested by SAE J949_200904.

In other examples, the molded composite article further comprises a flexural strength in the machine direction of about 6 MPa to about 17 MPa and a flexural strength in the cross direction of about 4 MPa to about 11 MPa as tested by SAE J949_200904.

In further examples, the molded composite article further comprises a flexural modulus in the machine direction of about 800 MPa to about 2000 MPa and a flexural modulus in the cross direction of about 500 MPa to about 1300 MPa as tested by SAE J949_200904.

In certain instances, the molded composite article further comprises a stiffness in the machine direction of about 10 N/cm to about 50 N/cm and a stiffness in the cross direction of about 7 N/cm to about 30 N/cm as tested by SAE J949_200904 and a flexural strength in the machine direction of about 6 MPa to about 17 MPa and a flexural strength in the cross direction of about 4 MPa to about 11 MPa as tested by SAE J949_200904.

In some embodiments, the molded composite article further comprises a stiffness in the machine direction of about 10 N/cm to about 50 N/cm and a stiffness in the cross direction of about 7 N/cm to about 30 N/cm as tested by SAE J949_200904 and a flexural modulus in the machine direction of about 800 MPa to about 2000 MPa and a flexural modulus in the cross direction of about 500 MPa to about 1300 MPa as tested by SAE J949_200904.

In certain examples, the molded composite article further comprises a flexural strength in the machine direction of about 6 MPa to about 17 MPa and a flexural modulus in the machine direction of about 800 MPa to about 2000 MPa and a flexural modulus in the cross direction of about 500 MPa to about 1300 MPa as tested by SAE J949_200904.

In some examples, the molded composite article further comprises a stiffness in the machine direction of about 10 N/cm to about 50 N/cm and a stiffness in the cross direction of about 7 N/cm to about 30 N/cm as tested by SAE J949_200904, a flexural strength in the machine direction of about 6 MPa to about 17 MPa and a flexural strength in the cross direction of about 4 MPa to about 11 MPa as tested by SAE J949_200904, and a flexural modulus in the machine direction of about 800 MPa to about 2000 MPa and a flexural modulus in the cross direction of about 500 MPa to about 1300 MPa as tested by SAE J949_200904.

In certain embodiments, the article is configured as an automotive headliner, an automotive interior component, as a cubicle panel or a furniture panel.

In another aspect, a molded porous composite article comprises a lofted core layer comprising a web formed from reinforcing fibers, bicomponent fibers, a lofting agent and a thermoplastic material, wherein the web comprises a porosity of about 20% to about 80%, and wherein the bicomponent fibers comprise a core-shell arrangement, wherein a shell material of the shell of the core-shell arrangement comprises a melting point that is substantially similar to a melting point of the thermoplastic material, and wherein a core material of the core of the core-shell arrangement comprises a melting point that is at least twenty degrees Celsius higher than the melting point of the thermoplastic material, and wherein the molded porous composite article comprises a stiffness in the machine direction of about 10 N/cm to about 50 N/cm and a stiffness in the cross direction of about 7 N/cm to about 30 N/cm as tested by SAE J949_200904.

In some examples, the molded composite article further comprises a flexural strength in the machine direction of about 6 MPa to about 17 MPa and a flexural strength in the cross direction of about 4 MPa to about 11 MPa as tested by SAE J949_200904.

In other examples, the molded composite article further comprises a flexural modulus in the machine direction of about 800 MPa to about 2000 MPa and a flexural modulus in the cross direction of about 500 MPa to about 1300 MPa as tested by SAE J949_200904.

In additional examples, the molded composite article further comprises a flexural strength in the machine direction of about 6 MPa to about 17 MPa and a flexural strength in the cross direction of about 4 MPa to about 11 MPa as tested by SAE J949_200904, and a flexural modulus in the machine direction of about 800 MPa to about 2000 MPa and a flexural modulus in the cross direction of about 500 MPa to about 1300 MPa as tested by SAE J949_200904.

In another aspect, a molded porous composite article comprises a lofted core layer comprising a web formed from reinforcing fibers, bicomponent fibers, a lofting agent and a thermoplastic material, wherein the web comprises a porosity of about 20% to about 80%, and wherein the bicomponent fibers comprise a core-shell arrangement, wherein a shell material of the shell of the core-shell arrangement comprises a melting point that is substantially similar to a melting point of the thermoplastic material, and wherein a core material of the core of the core-shell arrangement comprises a melting point that is at least twenty degrees Celsius higher than the melting point of the thermoplastic material, and wherein the molded porous composite article comprises a flexural strength in the machine direction of about 6 MPa to about 17 MPa and a flexural strength in the cross direction of about 4 MPa to about 11 MPa as tested by SAE J949_200904.

In certain examples, the molded composite article further comprises a flexural modulus in the machine direction of about 800 MPa to about 2000 MPa and a flexural modulus in the cross direction of about 500 MPa to about 1300 MPa as tested by SAE J949_200904.

In an additional aspect, a molded porous composite article comprises a lofted core layer comprising a web formed from reinforcing fibers, bicomponent fibers, a lofting agent and a thermoplastic material, wherein the web comprises a porosity of about 20% to about 80%, and wherein the bicomponent fibers comprise a core-shell arrangement, wherein a shell material of the shell of the core-shell arrangement comprises a melting point that is substantially similar to a melting point of the thermoplastic material, and wherein a core material of the core of the core-shell arrangement comprises a melting point that is at least twenty degrees Celsius higher than the melting point of the thermoplastic material, and wherein the molded porous composite article comprises a flexural modulus in the machine direction of about 800 MPa to about 2000 MPa and a flexural modulus in the cross direction of about 500 MPa to about 1300 MPa as tested by SAE J949_200904.

Additional aspects, examples, embodiments and configurations are described in more detail below.

### BRIEF DESCRIPTION OF THE SEVERAL VIEWS OF THE FIGURES

Certain aspects, embodiments and examples are described with reference to the accompanying figures in which:

FIG. 1 is an illustration of a core-shell fiber arrangement, in accordance with some examples;

FIG. 2 is an illustration of a side-by-side fiber arrangement, in accordance with certain embodiments;

FIGS. 3A and 3B are each illustrations of side-by-side fiber arrangements with a shell, in accordance with some examples;

FIG. 4 is an illustration of a core layer, in accordance with some examples;

FIG. 5 shows a process that can be used to produce a core layer, in accordance with some examples;

FIG. 6 shows another process that can be used to produce a core layer, in accordance with certain examples;

FIG. 7 is an illustration of an article comprising a core layer and a skin layer, in accordance with some examples;

FIG. 8 is an illustration of an article comprising a core layer and two skin layers, in accordance with some examples;

FIG. 9 is an illustration of an article comprising a core layer, a skin layer and a decorative layer, in accordance with some examples;

FIG. 10 is an illustration of an automotive headliner, in accordance with some examples;

FIG. 11 is an illustration of an automotive rear trim piece, in accordance with some examples;

FIG. 12 is an illustration of a furniture article, in accordance with some embodiments;

FIG. 13 is another illustration of a furniture article, in accordance with some embodiments;

FIG. 14 is another illustration of a furniture article, in accordance with some embodiments;

FIG. 15 is another illustration of a furniture article, in accordance with some embodiments;

FIG. 16 shows a photograph of a molded part produced using a hybrid light weight reinforced thermoplastic sheet;

FIG. 17 is a graph showing measured tensile modulus in a machine direction (MD) and cross direction (CD) for several samples;

FIG. 18 is a graph showing measured tensile strength in a machine direction (MD) and cross direction (CD) for several samples;

FIG. 19A is a graph comparing peak load in the machine direction for various samples; and

FIG. 19B is a graph comparing peak load in the cross direction for various samples.

It will be recognized by the person of ordinary skill in the art that the depictions and layers in the figures are provided merely for illustration purposes. No particular thickness, materials, dimensions of the like are intended to be implied or required unless otherwise described clearly in the description herein in connection with that particular illustration.

### DETAILED DESCRIPTION

Certain examples are described herein of composite articles that include a combination of thermoplastic materials and different fibers to provide improved properties. In some examples, one or more of peak load, stiffness, flexural strength and flexural modulus can be improved.

In certain embodiments, the articles produced herein are described in certain instances as light weight reinforced thermoplastic (LWRT) articles. In general, the articles comprise a core layer comprising a web formed from thermoplastic material, reinforcing fibers, bicomponent fibers and optionally a lofting agent. The presence of the combined materials can assist in enhanced properties.

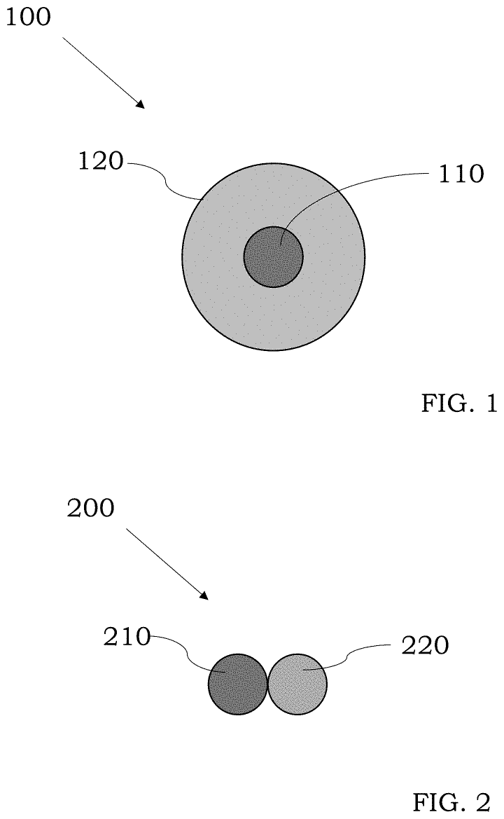

In certain configurations, the bicomponent fibers of the core layer may comprise two or more different materials that can be arranged in numerous different ways. For example, the bi-component fibers can be configured as a core-shell arrangement, a side-by-side arrangement or a combination of these arrangements with a shell surrounding a side-by-side arrangement of the fibers. The different fibers can be extruded, co-extruded, drawn or produced in similar manners that are used to produce fibers. In some examples, the produced fiber can be coated in another material to provide the shell around a core fiber. Where more than a single fiber is present in the shell, the fibers can be coaxial, e.g., remain untwisted, or may cross over or be twisted as desired. Referring to FIG. 1, an illustration showing a cross-section through a core-shell arrangement of bicomponent fibers is shown. The bicomponent fiber 100 comprises a core material 110 surrounded by a shell material 120. Each of the components 110, 120 may not be a fiber in the true sense, but together the materials of the core 110 and the shell 120 form a fiber. Alternatively, each of the materials 110, 120 could be considered a fiber. The shell material 120 need not completely surround the core material 110 or by symmetric. Without wishing to be bound by any particular theory, the shell material 120 is selected so it is compatible with the thermoplastic material, e.g., the thermoplastic resin, used to produce the core layer. For example, a melting point of the shell material 120 can be about the same or the same as a melting point of the thermoplastic material of the core layer. In some examples, the melting points of the shell material 120 and the thermoplastic material may differ by about one to about ten degrees Celsius and the materials can still be considered compatible.

In certain embodiments, the core material 110 typically comprises a higher melting point than the shell material 120 and the thermoplastic material. For example, as the core layer is formed, the shell material 120 and the thermoplastic material can be melted or softened to form the web of the core layer. The core material 110 typically remains solid and does not melt of soften to any substantial degree during processing of the materials to form the core layer.

In certain examples, a melting point of the core material 110 is at least fifteen degrees Celsius higher than a melting point of the shell material 120 or the melting point of the thermoplastic material. In some examples, a melting point of the core material 110 is at least twenty degrees Celsius higher than a melting point of the shell material 120 or the melting point of the thermoplastic material. In other examples, a melting point of the core material 110 is at least twenty-five degrees Celsius higher than a melting point of the shell material 120 or the melting point of the thermoplastic material. In other examples, a melting point of the core material 110 is at least thirty degrees Celsius higher than a melting point of the shell material 120 or the melting point of the thermoplastic material. In certain examples, a melting point of the core material 110 is at least thirty-five degrees Celsius higher than a melting point of the shell material 120 or the melting point of the thermoplastic material. In certain embodiments, a melting point of the core material 110 is at least forty degrees Celsius higher than a melting point of the shell material 120 or the melting point of the thermoplastic material. In other embodiments, a melting point of the core material 110 is at least forty-five degrees Celsius higher than a melting point of the shell material 120 or the melting point of the thermoplastic material. In other embodiments, a melting point of the core material 110 is at least fifty degrees Celsius higher than a melting point of the shell material 120 or the melting point of the thermoplastic material.

In certain configurations, the materials present in the shell 120 and the core 110 are not the same material. For example, the shell material 120 may comprise a polyolefin and the core material 110 may comprise a material with a melting point higher than the melting point of the polyolefin of the shell material 120. In other instances, the core material 110 may comprise a polyester, a polyamide or a co-polyamide and the shell material 120 may comprise a material with a lower melting point than a melting point of the polyester, a polyamide or a co-polyamide in the core material 110. In additional examples, the shell material 120 may comprise a polyolefin and the core material 110 may comprise a polyester, a polyamide or a co-polyamide. In some examples, the shell material 120 comprises a polyolefin and the core material 110 comprises a polyester. In other examples, the shell material 120 comprises a polyolefin and the core material 110 comprises a polyamide. In some examples, the shell material 120 comprises a polyolefin and the core material comprises a co-polyamide.

In some examples, the polyolefin of the shell material 120 may be polyethylene, polypropylene or other olefinic polymers and co-polymers. In some embodiments, the polyolefin material of the shell 120 may be considered a linear low density polyolefin. For example, the polyolefin material of the shell 120 may be a linear low density polyethylene (LLDPE) or a low density polyethylene (LDPE). While the exact material properties can vary, a linear low density polyethylene may comprise a density of about 0.91 g/cm3 to about 0.94 g/cm3. In some examples, a melting point of the LLDPE or LDPE can be at least fifteen degrees Celsius lower than a melting point of the core material 110. In certain examples, a melting point of the LLDPE or LDPE can be at least twenty degrees Celsius lower than a melting point of the core material 110. In other examples, of the LLDPE or LDPE can be at least twenty-five degrees Celsius lower than a melting point of the core material 110. In certain examples, a melting point of the LLDPE or LDPE can be at least thirty degrees Celsius lower than a melting point of the core material 110. In other examples, a melting point of the LLDPE or LDPE can be at least thirty-five degrees Celsius lower than a melting point of the core material 110. In certain examples, a melting point of the LLDPE or LDPE can be at least forty degrees Celsius lower than a melting point of the core material 110. In other examples, a melting point of the LLDPE or LDPE can be at least forty-five degrees Celsius lower than a melting point of the core material 110. In some examples, a melting point of the LLDPE or LDPE can be at least fifty degrees Celsius lower than a melting point of the core material 110.

In other examples, the core material 110 may comprise a polyester comprising monomeric units of a terephthalate. For example, the polyester may be polyethylene terephthalate, polybutylene terephthalate or polynaphthalene terephthalate. In certain examples, a melting point of the polyester comprising monomeric units of a terephthalate in the core material 110 may be at least fifteen degrees higher than a melting point of material in the shell material 120. In some examples, a melting point of the polyester comprising monomeric units of a terephthalate in the core material 110 may be at least twenty degrees higher than a melting point of material in the shell material 120. In certain examples, a melting point of the polyester comprising monomeric units of a terephthalate in the core material 110 may be at least twenty-five degrees higher than a melting point of material in the shell material 120. In other examples, a melting point of the polyester comprising monomeric units of a terephthalate in the core material 110 may be at least thirty degrees higher than a melting point of material in the shell material 120. In certain examples, a melting point of the polyester comprising monomeric units of a terephthalate in the core material 110 may be at least thirty-five degrees higher than a melting point of material in the shell material 120. In some examples, a melting point of the polyester comprising monomeric units of a terephthalate in the core material 110 may be at least forty degrees higher than a melting point of material in the shell material 120. In other examples, a melting point of the polyester comprising monomeric units of a terephthalate in the core material 110 may be at least forty-five degrees higher than a melting point of material in the shell material 120. In additional examples, a melting point of the polyester comprising monomeric units of a terephthalate in the core material 110 may be at least fifty degrees higher than a melting point of material in the shell material 120.

In some embodiments, the core material 110 may comprise a polyamide or a co-polyamide. For example, the core material 110 may comprise nylon, nylon 66, aramid, polyesteramides, polyetheramides, polyetheresteramides, or other polyamide-containing copolymers. In certain examples, a melting point of the polyamide or co-polyamide in the core material 110 may be at least fifteen degrees higher than a melting point of material in the shell material 120. In some examples, a melting point of the polyamide or co-polyamide in the core material 110 may be at least twenty degrees higher than a melting point of material in the shell material 120. In certain examples, a melting point of the polyamide or co-polyamide in the core material 110 may be at least twenty-five degrees higher than a melting point of material in the shell material 120. In other examples, a melting point of the polyamide or co-polyamide in the core material 110 may be at least thirty degrees higher than a melting point of material in the shell material 120. In certain examples, a melting point of the polyamide or co-polyamide in the core material 110 may be at least thirty-five degrees higher than a melting point of material in the shell material 120. In some examples, a melting point of the polyamide or co-polyamide in the core material 110 may be at least forty degrees higher than a melting point of material in the shell material 120. In other examples, a melting point of the polyamide or co-polyamide in the core material 110 may be at least forty-five degrees higher than a melting point of material in the shell material 120. In additional examples, a melting point of the polyamide or co-polyamide in the core material 110 may be at least fifty degrees higher than a melting point of material in the shell material 120.

In certain examples, the shell material 120 may comprise a polyethylene, e.g., a LLDPE, and the core material 110 may comprise a polyester or a polyamide. For example, the core material 110 may comprise nylon, polyethylene terephthalate, polybutylene terephthalate, polynaphthalene terephthalate, or combinations thereof. In certain examples, a melting point of the polyester or polyamide in the core material 110 may be at least fifteen degrees higher than a melting point of the polyethylene material in the shell material 120. In some examples, a melting point of the polyester or polyamide in the core material 110 may be at least twenty degrees higher than a melting point of the polyethylene material in the shell material 120. In certain examples, a melting point of the polyester or polyamide in the core material 110 may be at least twenty-five degrees higher than a melting point of the polyethylene material in the shell material 120. In other examples, a melting point of the polyester or polyamide in the core material 110 may be at least thirty degrees higher than a melting point of the polyethylene material in the shell material 120. In certain examples, a melting point of the polyester or polyamide in the core material 110 may be at least thirty-five degrees higher than a melting point of the polyethylene material in the shell material 120. In some examples, a melting point of the polyester or polyamide in the core material 110 may be at least forty degrees higher than a melting point of the polyethylene material in the shell material 120. In other examples, a melting point of the polyester or polyamide in the core material 110 may be at least forty-five degrees higher than a melting point of the polyethylene material in the shell material 120. In additional examples, a melting point of the polyester or polyamide in the core material 110 may be at least fifty degrees higher than a melting point of the polyethylene material in the shell material 120.

In other instances, the bicomponent fibers present in the LWRT articles may comprise a side-to-side fiber arrangement. Referring to FIG. 2, an illustration showing a cross-section through a side-by-side fiber arrangement of bicomponent fibers is shown. The bicomponent fiber 200 comprise a first fiber 210 arranged to the side of a second fiber 220. The fibers 210, 220 can be twisted around each other or may remain untwisted and run generally co-axial with each other throughout the fiber 200. Without wishing to be bound by any particular theory, a melting point of materials in one of the fibers 210, 220 is typically about the same as or the same as a melting point of the thermoplastic material of the core layer. In some examples, the melting points of one of the fibers 210, 220 and the thermoplastic material may differ by about one to about ten degrees Celsius and the materials can still be considered compatible.

In certain embodiments, the fiber 210 typically comprises a higher melting point than the other fiber 220 and the thermoplastic material. For example, as the core layer is formed, the fiber 220 and the thermoplastic material can be melted or softened to form the web of the core layer. The fiber 210 typically remains solid and does not melt of soften to any substantial degree during processing of the materials to form the core layer. In certain examples, a melting point of the fiber 210 is at least fifteen degrees Celsius higher than a melting point of the fiber 220 or the melting point of the thermoplastic material. In some examples, a melting point of the fiber 210 is at least twenty degrees Celsius higher than a melting point of the fiber 220 or the melting point of the thermoplastic material. In other examples, a melting point of the fiber 210 is at least twenty-five degrees Celsius higher than a melting point of the fiber 220 or the melting point of the thermoplastic material. In other examples, a melting point of the fiber 210 is at least thirty degrees Celsius higher than a melting point of the fiber 220 or the melting point of the thermoplastic material. In certain examples, a melting point of the fiber 210 is at least thirty-five degrees Celsius higher than a melting point of the fiber 220 or the melting point of the thermoplastic material. In certain embodiments, a melting point of the fiber 210 is at least forty degrees Celsius higher than a melting point of the fiber 220 or the melting point of the thermoplastic material. In other embodiments, a melting point of the fiber 210 is at least forty-five degrees Celsius higher than a melting point of the fiber 220 or the melting point of the thermoplastic material. In other embodiments, a melting point of the fiber 210 is at least fifty degrees Celsius higher than a melting point of the fiber 220 or the melting point of the thermoplastic material.

In certain configurations, the materials present in the fibers 210, 220 are not the same material. For example, the fiber 220 may comprise a polyolefin and the fiber 210may comprise a material with a melting point higher than the melting point of the polyolefin of the shell material 120. In other instances, the fiber 210 may comprise a polyester, a polyamide or a co-polyamide and the fiber 220 may comprise a material with a lower melting point than a melting point of the polyester, a polyamide or a co-polyamide in the fiber 210. In additional examples, the fiber 220 may comprise a polyolefin and the fiber 210 may comprise a polyester, a polyamide or a co-polyamide. In some examples, the fiber 220 comprises a polyolefin and the fiber 210 comprises a polyester. In other examples, the fiber 220 comprises a polyolefin and the fiber 210 comprises a polyamide. In some examples, the fiber 220 comprises a polyolefin and the fiber 210 comprises a co-polyamide.

In some examples, the polyolefin of the fiber 220 may be polyethylene, polypropylene or other olefinic polymers and co-polymers. In some embodiments, the polyolefin material of the fiber 220 may be considered a linear low density polyolefin. For example, the polyolefin material of the fiber 220 may be a linear low density polyethylene (LLDPE) or a low density polyethylene (LDPE). While the exact material properties can vary, a linear low density polyethylene may comprise a density of about 0.91 g/cm3 to about 0.94 g/cm3. In some examples, a melting point of the LLDPE or LDPE can be at least fifteen degrees Celsius lower than a melting point of the fiber 210. In certain examples, a melting point of the LLDPE or LDPE can be at least twenty degrees Celsius lower than a melting point of the fiber 210. In other examples, a melting point of the LLDPE or LDPE can be at least twenty-five degrees Celsius lower than a melting point of the fiber 210. In certain examples, a melting point of the LLDPE or LDPE can be at least thirty degrees Celsius lower than a melting point of the core material 110. In other examples, a melting point of the LLDPE or LDPE can be at least thirty-five degrees Celsius lower than a melting point of the fiber 210. In certain examples, a melting point of the LLDPE or LDPE can be at least forty degrees Celsius lower than a melting point of the fiber 210. In other examples, a melting point of the LLDPE or LDPE can be at least forty-five degrees Celsius lower than a melting point of the fiber 210. In some examples, a melting point of the LLDPE or LDPE can be at least fifty degrees Celsius lower than a melting point of the fiber 210.

In other examples, the fiber 210 may comprise a polyester comprising monomeric units of a terephthalate. For example, the polyester may be polyethylene terephthalate, polybutylene terephthalate or polynaphthalene terephthalate. In certain examples, a melting point of the polyester comprising monomeric units of a terephthalate in the fiber 210 may be at least fifteen degrees higher than a melting point of material in the fiber 220. In some examples, a melting point of the polyester comprising monomeric units of a terephthalate in the fiber 210 may be at least twenty degrees higher than a melting point of material in the fiber 220. In certain examples, a melting point of the polyester comprising monomeric units of a terephthalate in the fiber 210 may be at least twenty-five degrees higher than a melting point of material in the fiber 220. In other examples, a melting point of the polyester comprising monomeric units of a terephthalate in the fiber 210 may be at least thirty degrees higher than a melting point of material in the fiber 220. In certain examples, a melting point of the polyester comprising monomeric units of a terephthalate in the fiber 210 may be at least thirty-five degrees higher than a melting point of material in the fiber 220. In some examples, a melting point of the polyester comprising monomeric units of a terephthalate in the fiber 210 may be at least forty degrees higher than a melting point of material in the fiber 220. In other examples, a melting point of the polyester comprising monomeric units of a terephthalate in the fiber 210 may be at least forty-five degrees higher than a melting point of material in the fiber 220. In additional examples, a melting point of the polyester comprising monomeric units of a terephthalate in the fiber 210 may be at least fifty degrees higher than a melting point of material in the fiber 220.

In some embodiments, the fiber 210 may comprise a polyamide or a co-polyamide. For example, the fiber 210 may comprise nylon, nylon 66, aramid, polyesteramides, polyetheramides, polyetheresteramides, or other polyamide-containing copolymers. In certain examples, a melting point of the polyamide or co-polyamide in the fiber 210 may be at least fifteen degrees higher than a melting point of material in the fiber 220. In some examples, a melting point of the polyamide or co-polyamide in the fiber 210 may be at least twenty degrees higher than a melting point of material in the fiber 220. In certain examples, a melting point of the polyamide or co-polyamide in the fiber 210 may be at least twenty-five degrees higher than a melting point of material in the fiber 220. In other examples, a melting point of the polyamide or co-polyamide in the fiber 210 may be at least thirty degrees higher than a melting point of material in the fiber 220. In certain examples, a melting point of the polyamide or co-polyamide in the fiber 210 may be at least thirty-five degrees higher than a melting point of material in the fiber 220. In some examples, a melting point of the polyamide or co-polyamide in the fiber 210 may be at least forty degrees higher than a melting point of material in the fiber 220. In other examples, a melting point of the polyamide or co-polyamide in the fiber 210 may be at least forty-five degrees higher than a melting point of material in the fiber 220. In additional examples, a melting point of the polyamide or co-polyamide in the fiber 210 may be at least fifty degrees higher than a melting point of material in the fiber 220.

In certain examples, the fiber 220 may comprise a polyethylene, e.g., a LLDPE, and the fiber 210 may comprise a polyester or a polyamide. For example, the fiber 210 may comprise nylon, polyethylene terephthalate, polybutylene terephthalate, polynaphthalene terephthalate, or combinations thereof. In certain examples, a melting point of the polyester or polyamide in the fiber 210 may be at least fifteen degrees higher than a melting point of the polyethylene material in the fiber 220. In some examples, a melting point of the polyester or polyamide in the core fiber 210 may be at least twenty degrees higher than a melting point of the polyethylene material in the fiber 220. In certain examples, a melting point of the polyester or polyamide in the fiber 210 may be at least twenty-five degrees higher than a melting point of the polyethylene material in the fiber 220. In other examples, a melting point of the polyester or polyamide in the fiber 210 may be at least thirty degrees higher than a melting point of the polyethylene material in the fiber 220. In certain examples, a melting point of the polyester or polyamide in the fiber 210 may be at least thirty-five degrees higher than a melting point of the polyethylene material in the fiber 220. In some examples, a melting point of the polyester or polyamide in the fiber 210 may be at least forty degrees higher than a melting point of the polyethylene material in the fiber220. In other examples, a melting point of the polyester or polyamide in the fiber 210 may be at least forty-five degrees higher than a melting point of the polyethylene material in the fiber 220. In additional examples, a melting point of the polyester or polyamide in the fiber 210 may be at least fifty degrees higher than a melting point of the polyethylene material in the fiber 220.

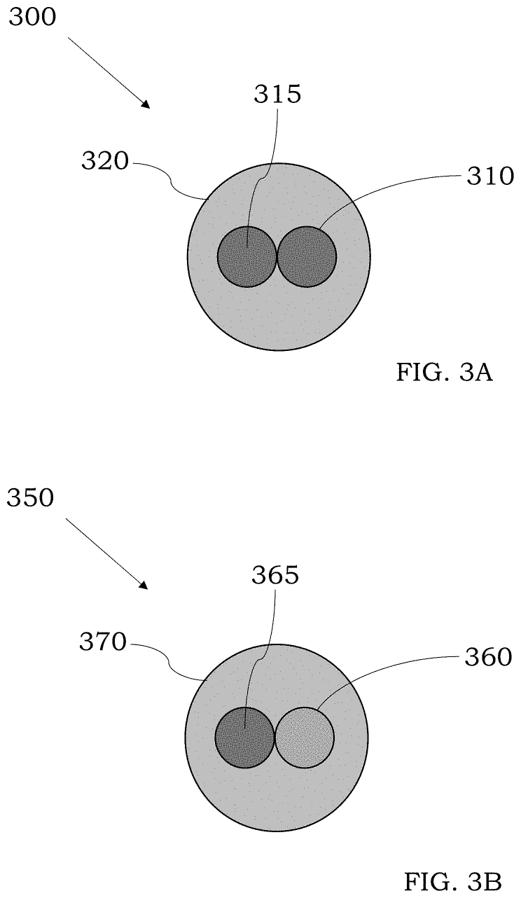

Referring to FIG. 3A, an illustration showing a cross-section through a side-by-side fiber arrangement with a shell surrounding the side-by-side fiber arrangement of bi-components fibers is shown. For example, the fiber 300 comprises a shell 320 that surrounds two fibers 310, 315. In FIG. 3A, the fibers 310, 315 may comprise the same or similar compositions. For example, each of the fibers 310, 315 may independently comprise the same materials as described in connection with the core material 110 in FIG. 1, e.g., each of the fibers 310, 315 may independently comprise a polyamide, polyester or other polymer.

In certain embodiments, the shell material 320 may comprise a polyolefin. In some examples, the polyolefin of the shell material 320 may be polyethylene, polypropylene or other olefinic polymers and co-polymers. In some embodiments, the polyolefin material of the shell 320 may be considered a linear low density polyolefin. For example, the polyolefin material of the shell 320 may be a linear low density polyethylene (LLDPE) or a low density polyethylene (LDPE). While the exact material properties can vary, a linear low density polyethylene may comprise a density of about 0.91 g/cm3 to about 0.94 g/cm3. In some examples, a melting point of the LLDPE or LDPE can be at least fifteen degrees Celsius lower than a melting point of the fibers 310, 315. In certain examples, a melting point of the LLDPE or LDPE can be at least twenty degrees Celsius lower than a melting point of the fibers 310, 315. In other examples, of the LLDPE or LDPE can be at least twenty-five degrees Celsius lower than a melting point of the fibers 310, 315. In certain examples, a melting point of the LLDPE or LDPE can be at least thirty degrees Celsius lower than a melting point of the fibers 310, 315. In other examples, a melting point of the LLDPE or LDPE can be at least thirty-five degrees Celsius lower than a melting point of the fibers 310, 315. In certain examples, a melting point of the LLDPE or LDPE can be at least forty degrees Celsius lower than a melting point of the fibers 310, 315. In other examples, a melting point of the LLDPE or LDPE can be at least forty-five degrees Celsius lower than a melting point of the fibers 310, 315. In some examples, a melting point of the LLDPE or LDPE can be at least fifty degrees Celsius lower than a melting point of the fibers 310, 315.

In certain examples, the fibers 310, 315 may independently comprise a polyester or a polyamide. In some instances, the fibers 310, 315 independently comprise may comprise nylon, polyethylene terephthalate, polybutylene terephthalate, polynaphthalene terephthalate, or combinations thereof. In certain examples, a melting point of the polyester or polyamide in the fibers 310, 315 may be at least fifteen degrees higher than a melting point of the polyethylene material in the shell material 320. In some examples, a melting point of the polyester or polyamide in the fibers 310, 315 may be at least twenty degrees higher than a melting point of the polyethylene material in the shell material 320. In certain examples, a melting point of the polyester or polyamide in the fibers 310, 315 may be at least twenty-five degrees higher than a melting point of the polyethylene material in the shell material 320. In other examples, a melting point of the polyester or polyamide in the fibers 310, 315 may be at least thirty degrees higher than a melting point of the polyethylene material in the shell material 320. In certain examples, a melting point of the polyester or polyamide in the fibers 310, 315 may be at least thirty-five degrees higher than a melting point of the polyethylene material in the shell material 320. In some examples, a melting point of the polyester or polyamide in the fibers 310, 315 may be at least forty degrees higher than a melting point of the polyethylene material in the shell material 320. In other examples, a melting point of the polyester or polyamide in the fibers 310, 315 may be at least forty-five degrees higher than a melting point of the polyethylene material in the shell material 320. In additional examples, a melting point of the polyester or polyamide in the fibers 310, 315 may be at least fifty degrees higher than a melting point of the polyethylene material in the shell material 320.

While FIG. 3A shows two side-by-side fibers which may comprise the same composition, this configuration is not required. For example and referring to FIG. 3B, a side-by-side arrangement of fibers 360, 365 surrounded by a shell 370 is shown. The fibers 360, 365 need not have the same composition as each other, but the melting point of each of the fibers 360, 365 is typically higher than a melting point of the shell 370 in the fiber arrangement 350. In one configuration, one of the fibers 360, 365 is a reinforcing fiber as noted below, e.g., inorganic fibers such as glass fibers, graphite fibers, carbon fibers, etc., and the other of the fibers 360, 365 is an organic fiber, e.g., comprises one or more covalently bonded carbon-hydrogen groups. By packaging the inorganic and organic fibers in a shell, addition of the fibers during processing of the materials to form a core layer can be simplified. In other examples, the fibers 360, 365 can each be organic fibers with a different composition.

In certain embodiments, the shell material 370 may comprise a polyolefin. In some examples, the polyolefin of the shell material 370 may be polyethylene, polypropylene or other olefinic polymers and co-polymers. In some embodiments, the polyolefin material of the shell 370 may be considered a linear low density polyolefin. For example, the polyolefin material of the shell 370 may be a linear low density polyethylene (LLDPE) or a low density polyethylene (LDPE). While the exact material properties can vary, a linear low density polyethylene may comprise a density of about 0.91 g/cm3 to about 0.94 g/cm3. In some examples, a melting point of the LLDPE or LDPE can be at least fifteen degrees Celsius lower than a melting point of the fibers 360, 365. In certain examples, a melting point of the LLDPE or LDPE can be at least twenty degrees Celsius lower than a melting point of the fibers 360, 365. In other examples, of the LLDPE or LDPE can be at least twenty-five degrees Celsius lower than a melting point of the fibers 360, 365. In certain examples, a melting point of the LLDPE or LDPE can be at least thirty degrees Celsius lower than a melting point of the fibers 360, 365. In other examples, a melting point of the LLDPE or LDPE can be at least thirty-five degrees Celsius lower than a melting point of the fibers 360, 365. In certain examples, a melting point of the LLDPE or LDPE can be at least forty degrees Celsius lower than a melting point of the fibers 360, 365. In other examples, a melting point of the LLDPE or LDPE can be at least forty-five degrees Celsius lower than a melting point of the fibers 360, 365. In some examples, a melting point of the LLDPE or LDPE can be at least fifty degrees Celsius lower than a melting point of the fibers 360, 365.

In certain examples, the fibers 360, 365 may independently comprise a polyester or a polyamide or one of the fibers 360, 365 may be an inorganic reinforcing fiber. In some instances, the fibers 360, 365 independently comprise may comprise nylon, polyethylene terephthalate, polybutylene terephthalate, polynaphthalene terephthalate, or combinations thereof. In certain examples, a melting point of the materials in the fibers 360, 365may be at least fifteen degrees higher than a melting point of the polyethylene material in the shell material 370. In some examples, a melting point of the materials in the fibers 360, 365may be at least twenty degrees higher than a melting point of the polyethylene material in the shell material 370. In certain examples, a melting point of the materials in the fibers 360, 365 may be at least twenty-five degrees higher than a melting point of the polyethylene material in the shell material 370. In other examples, a melting point of the materials in the fibers 360, 365 may be at least thirty degrees higher than a melting point of the polyethylene material in the shell material 370. In certain examples, a melting point of the materials in the fibers 360, 365 may be at least thirty-five degrees higher than a melting point of the polyethylene material in the shell material 320. In some examples, a melting point of the materials in the fibers 360, 365 may be at least forty degrees higher than a melting point of the polyethylene material in the shell material 370. In other examples, a melting point of the materials in the fibers 360, 365 may be at least forty-five degrees higher than a melting point of the polyethylene material in the shell material 370. In additional examples, a melting point of the materials in the fibers 360, 365 may be at least fifty degrees higher than a melting point of the polyethylene material in the shell material 370.

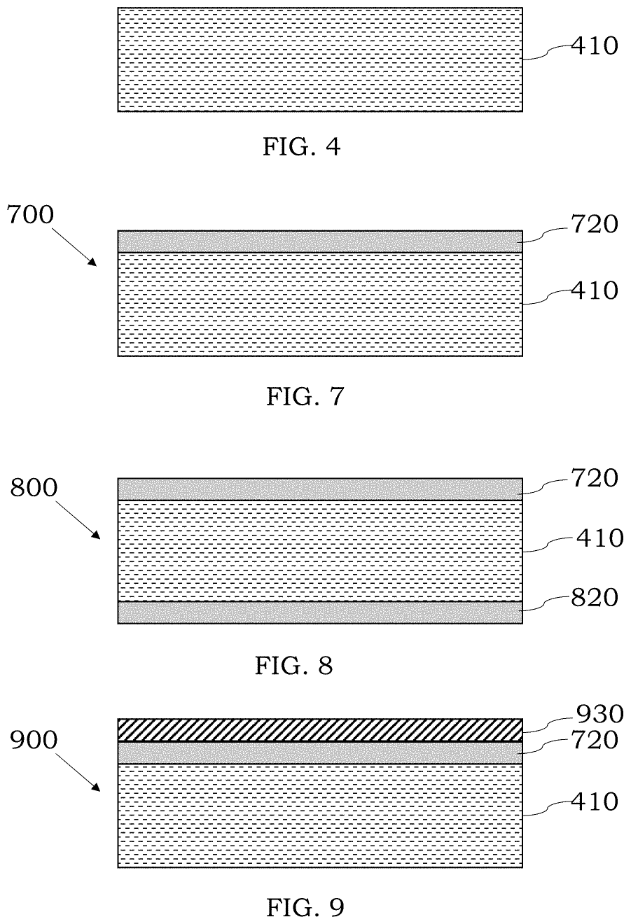

In certain embodiments and referring to FIG. 4, a core layer 410 is shown that comprises a thermoplastic material, reinforcing fibers, bicomponent fibers and a lofting agent. As discussed further below, the combination of these materials can provide improved mechanical properties. While not true in all configurations, the lofting agent typically becomes trapped in the voids or pores of the core layer 410. The core layer 410 may first be formed as a prepreg which is generally a precursor to the core layer 410 and is not necessarily fully formed. For ease of illustration, a core layer is described below, though the properties of the core layer may also be the same as a prepreg. The core layer 410 comprises a porous structure to permit gases to flow through the core layer. For example, the core layer may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the core layer 410 comprises a porosity or void content of greater than 0%, e.g., is not fully consolidated, up to about 95%. Unless otherwise stated, the reference to the core layer comprising a certain void content or porosity is based on the total volume of the core layer and not necessarily the total volume of the core layer plus any other materials or layers coupled to the core layer.

In certain embodiments, by including the polymeric bicomponent fibers in the core layer 410 improved mechanical properties can be achieved. For example, increasing the amount of the reinforcing fibers in the core layer 410 can often degrade certain mechanical properties. Inclusion of the bicomponent fibers in the core layer can, for example, improve one or more of peak load values, stiffness values, flexural strength values and flexural modulus values for a selected molding thickness. These values can be measured, for example, using SAEJ949 dated April 2009 (also referred to as SAEJ949_200904). In brief, the SAEJ949 protocol used subjects a sample to a three-point bending test and measures the various performance values.

In certain embodiments, the thermoplastic material of the core layer 410 may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. The virgin thermoplastic material used to form the core layer can be used in powder form, resin form, rosin form, fiber form or other suitable forms. Illustrative thermoplastic materials in various forms are described herein and are also described, for example in U.S. Publication Nos. 20130244528 and US20120065283. The exact amount of thermoplastic material present in the core layer 410 can vary and illustrative amounts range from about 20% by weight to about 80% by weight. As noted herein, the material of the core layer 410 can be selected such that its melting point is about the same as one of the materials in the bicomponent fibers and is less than a melting point of another material in the bicomponent fibers. Illustrative melting point ranges for the thermoplastic material include, but are not limited to, about 120 degrees Celsius to about 260 degrees Celsius. If desired, thermoplastic materials that melt between 100 degrees Celsius and 315 degrees Celsius can also be used.

In certain examples, the reinforcing fibers of the core layer described herein can comprise glass fibers, carbon fibers, graphite fibers, synthetic organic fibers, particularly high modulus organic fibers such as, for example, para- and meta-aramid fibers, nylon fibers, polyester fibers, or any high melt flow index resins that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some instances, one type of the reinforcing fibers may be used along with mineral fibers such as, for example, fibers formed by spinning or drawing molten minerals. Illustrative mineral fibers include, but are not limited to, mineral wool fibers, glass wool fibers, stone wool fibers, and ceramic wool fibers. In some examples, the reinforcing fibers can be selected to be inorganic fibers, e.g., fibers not including covalently bonded carbon-hydrogen groups.

In some embodiments, any of the aforementioned reinforcing fibers can be chemically treated prior to use to provide desired functional groups or to impart other physical properties to the fibers. The total fiber content in the core layer (reinforcing fibers+bicomponent fibers) may be from about 20% to about 90% by weight of the core layer, more particularly from about 30% to about 70%, by weight of the core layer. Typically, the total fiber content of a composite article comprising the core layer varies between about 20% to about 90% by weight, more particularly about 30% by weight to about 80% by weight, e.g., about 40% to about 70% by weight of the composite. The particular size and/or orientation of the reinforcing fibers used may depend, at least in part, on the polymer material used and/or the desired properties of the resulting core layer. Suitable additional types of fibers, fiber sizes and amounts will be readily selected by the person of ordinary skill in the art, given the benefit of this disclosure. In one non-limiting illustration, reinforcing fibers dispersed within a thermoplastic material to provide a core layer generally have a diameter of greater than about 5 microns, more particularly from about 5 microns to about 22 microns, and a length of from about 5 mm to about 200 mm. More particularly, the reinforcing fiber diameter may be from about 5 microns to about 22 microns and the fiber length may be from about 5 mm to about 75 mm. In some configurations, the flame retardant material may be present in fiber form. For example, the core layer may comprise a thermoplastic material, reinforcing fibers, bicomponent fibers and fibers comprising a flame retardant material.

In some configurations, the core layer 410 may be a substantially halogen free or halogen free layer to meet the restrictions on hazardous substances requirements for certain applications. In other instances, the core layer 410 may comprise a halogenated flame retardant agent (which can be present in the flame retardant material or may be added in addition to the flame retardant material) such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 410 may comprise one or more halogens to impart some flame retardancy without the addition of another flame retardant agent. For example, the thermoplastic material may be halogenated in addition to there being a flame retardant material present, or the virgin thermoplastic material may be halogenated and used by itself. Where halogenated flame retardants are present, the flame retardant is desirably present in a flame retardant amount, which can vary depending on the other components which are present. For example, the halogenated flame retardant where present in addition to the flame retardant material may be present in about 0.1 weight percent to about 40 weight percent (based on the weight of the prepreg), more particularly about 0.1 weight percent to about 15 weight percent, e.g., about 5 weight percent to about 15 weight percent. If desired, two different halogenated flame retardants may be added to the core layer 410. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the core layer 410 may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 40 weight percent (based on the weight of the prepreg), more particularly about 5 weight percent to about 40 weight percent, e.g., about 5 weight percent to about 15 weight percent based on the weight of the core layer. If desired, two different substantially halogen free flame retardants may be added to the core layer 410. In certain instances, the core layer 410 described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 40 weight percent (based on the weight of the prepreg or core), more particularly about 5 weight percent to about 40 weight percent, e.g., about 2 weight percent to about 14 weight percent based on the weight of the core layer. The flame retardant agents used in the core layers described herein can be added to the mixture comprising the thermoplastic material, bicomponent fibers and reinforcing fibers (prior to disposal of the mixture on a wire screen or other processing component) or can be added after the core layer 410 is formed.

As noted herein, the core layer 410 may comprise a lofting agent present in the pores or voids of the core layer. The lofting agent may take the form of expandable microspheres whose volume can increase upon exposure to heat or other stimulus. For example, a thickness of the core layer 410 can be increased by expanding the lofting agent. The exact amount of the lofting agent present in the core layer 410 may vary, and illustrative amounts include, but are not limited to, about 0.5 weight percent to about 30 weight percent.

In certain embodiments, the exact amount of the bicomponent fibers in the core layers described herein may vary. In general, the weight percentages of the bicomponent fibers in the core layer may vary from about 2 weight percent to about 30 weight percent. In some examples, about the same amount of bicomponent fibers and reinforcing fibers are present in the core layer. In some examples, the overall basis weight of the core layer 410 may vary from about 500 gsm to about 3500 gsm. In some examples, lighter core layers with suitable mechanical properties can be more desirable to reduce overall weight, e.g., a basis weight of the core layer 410 can vary from about 750 gsm to about 1500 gsm or about 750 gsm to about 1250 gsm.

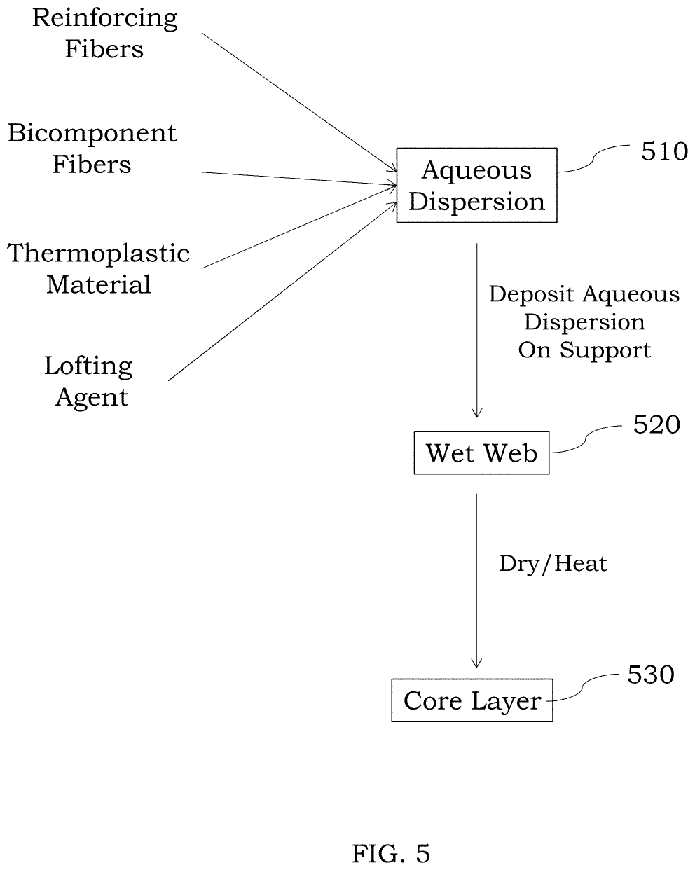

In certain embodiments, the core layers and/or articles described herein can be generally prepared using the reinforcing fibers, bicomponent fibers, lofting agent and a thermoplastic material as shown in FIG. 5. To produce the core layer, a thermoplastic material, reinforcing fibers, bicomponent fibers, lofting agent and optionally other materials can be added or metered into a dispersing foam contained in an open top mixing tank fitted with an impeller at a step 510 to provide an aqueous dispersion of the materials. Without wishing to be bound by any particular theory, the presence of trapped pockets of air of the foam can assist in dispersing the reinforcing fibers, the bicomponent fibers, the thermoplastic material, the lofting agent and any other materials. In some examples, the dispersed mixture of fibers, lofting agent and thermoplastic can be pumped to a head-box located above a wire section of a paper machine via a distribution manifold. For example, the aqueous mixture can be deposited on a moving wire screen or other support element at a step 520. The foam, not the fibers, lofting agent or thermoplastic material, can then be removed as the dispersed mixture is provided to a moving support such as a wire screen using a pressure, continuously producing a uniform, fibrous wet web with lofting agent trapped in the web. The wet web can be passed through a dryer at a suitable temperature to reduce moisture content and to melt or soften the thermoplastic material and at least one material of the bicomponent fibers to provide a core layer at step 530. When the hot web exits the dryer, an optional surface or skin layer such as, for example, a textured film may be laminated onto the web by passing the web of reinforcing fiber, bicomponent fibers, thermoplastic material, lofting agent and textured film through the nip of a set of heated rollers. If desired, additional layers such as, for example, another film layer, scrim layer, etc. may also be attached along with the textured film to one side or to both sides of the web to facilitate ease of handling the produced composite. The composite can then be passed through tension rolls and continuously cut (guillotined) into the desired size for later forming into an end composite article. Further information concerning the preparation of such composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865.

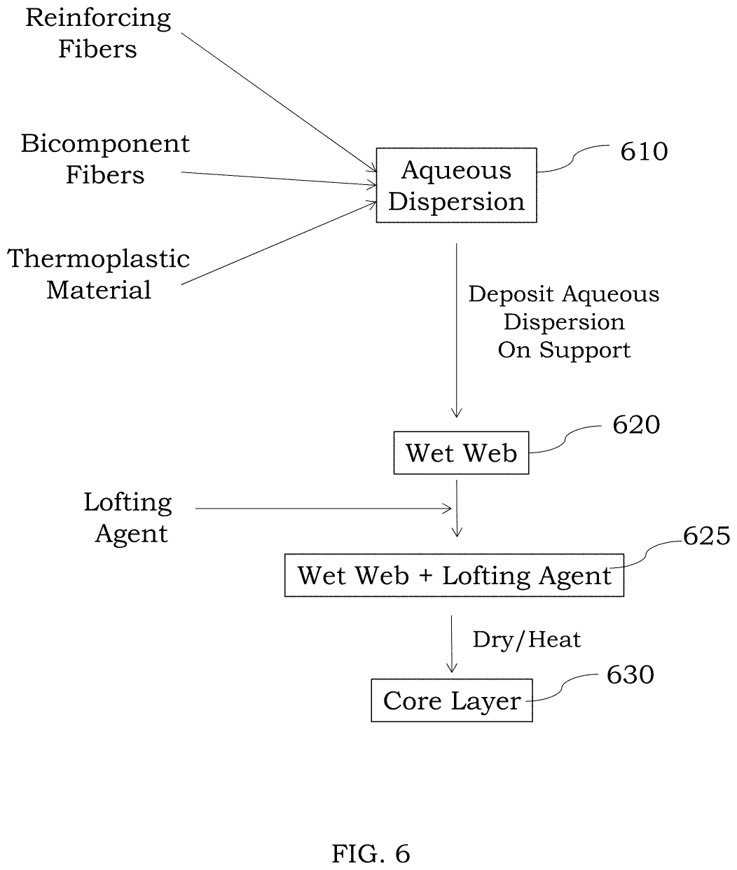

In another configuration, the core layers and/or articles described herein can be generally prepared using the reinforcing fibers, bicomponent fibers, and a thermoplastic material as shown in FIG. 6. To produce the core layer, a thermoplastic material, reinforcing fibers, bicomponent fibers, and optionally other materials can be added or metered into a dispersing foam contained in an open top mixing tank fitted with an impeller to provide an aqueous dispersion at a step 610. Without wishing to be bound by any particular theory, the presence of trapped pockets of air of the foam can assist in dispersing the reinforcing fibers, the bicomponent fibers, the thermoplastic material, and any other materials. In some examples, the dispersed mixture of fibers and thermoplastic can be pumped to a head-box located above a wire section of a paper machine via a distribution manifold. For example, the aqueous mixture can be deposited on a moving wire screen or other support element at a step 620 to provide a wet web. The foam, not the fibers or thermoplastic material, can then be removed as the dispersed mixture is provided to a moving support such as a wire screen using a pressure, continuously producing a uniform, fibrous wet web. A lofting agent can be then deposited or sprayed on top of the wet web at a step 625 to provide a wet web that includes the lofting agent. The wet web comprising the deposited lofting agent can be passed through a dryer optionally under vacuum or by applying pressure and heat at a suitable temperature to reduce moisture content and to melt or soften the thermoplastic material and at least one material of the bicomponent fibers to provide a core layer at a step 630. When the hot web exits the dryer, an optional surface or skin layer such as, for example, a textured film may be laminated onto the web by passing the web of reinforcing fiber, bicomponent fibers, thermoplastic material, lofting agent and textured film through the nip of a set of heated rollers. If desired, additional layers such as, for example, another film layer, scrim layer, etc. may also be attached along with the textured film to one side or to both sides of the web to facilitate ease of handling the produced composite. The composite can then be passed through tension rolls and continuously cut (guillotined) into the desired size for later forming into an end composite article. In certain embodiments, the core layers described herein can be used with a skin layer to provide a composite article. Referring to FIG. 7, a skin layer 720 is shown as being disposed on a first surface of the core layer 410 to provide a composite article 700. The skin layer 720 may comprise, for example, a film, a scrim (e.g., fiber based scrim), a frim (film+scrim), a foil, a woven fabric, a non-woven fabric or be present as an inorganic coating, an organic coating, or a thermoset coating disposed on the core layer. In other instances, the layer 720 may comprise a limiting oxygen index greater than about 22, as measured per ISO 4589 dated 1996. Where a fiber based scrim is present as (or as part of) the skin layer 720, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 720, the coating may comprise at least one of unsaturated polyurethanes, vinyl esters, phenolics and epoxies. Where an inorganic coating is present as (or as part of) the layer 720, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 720, the non-woven fabric may comprise a thermoplastic material, a thermal setting binder, inorganic fibers, metal fibers, metallized inorganic fibers and metallized synthetic fibers. If desired, an intermediate layer (not shown) can be present between the core layer and the skin layer 720. For example, an adhesive layer or layer of other material can be present between the core layer 410 and the skin layer 720.

In some examples, a composite article may also comprise a second skin layer disposed on another surface of a core layer. Referring to FIG. 8, a composite article 800 is shown comprising skin layers 720, 820 that sandwich a core layer 410. The layer 820 may be the same or may be different than the layer 720. In some instances, the layer 820 may comprise, for example, a film, a scrim (e.g., fiber based scrim), a frim (film+scrim), a foil, a woven fabric, a non-woven fabric or be present as an inorganic coating, an organic coating, or a thermoset coating disposed on the core layer. In other instances, the layer 820 may comprise a limiting oxygen index greater than about 22, as measured per ISO 4589 dated 1996. Where a fiber based scrim is present as (or as part of) the layer 820, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 820, the coating may comprise at least one of unsaturated polyurethanes, vinyl esters, phenolics and epoxies. Where an inorganic coating is present as (or as part of) the layer 820, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 820, the non-woven fabric may comprise a thermoplastic material, a thermal setting binder, inorganic fibers, metal fibers, metallized inorganic fibers and metallized synthetic fibers. If desired, an intermediate layer (not shown) can be present between the core layer and the skin layer 820. For example, an adhesive layer or layer of other material can be present between the core layer 410 and the skin layer 820.

In certain configurations, a composite article can include a decorative layer disposed on a surface of the core layer or on a skin layer. Referring to FIG. 9, an article 900 is shown that comprises a decorative layer 830 disposed on the skin layer 720. While not shown, a decorative layer could be disposed on an opposite surface of the core layer 410 or can be disposed on the skin layer 820 shown in FIG. 8. In some examples, the decorative layer 930 may be configured as a decorative layer, textured layer, colored layer and the like. For example, a decorative layer 930 may be formed, e.g., from a thermoplastic film of polyvinyl chloride, polyolefins, thermoplastic polyesters, thermoplastic elastomers, or the like. The decorative layer 930 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 930 may also be produced using spunbond, thermal bonded, spun lace, melt-blown, wet-laid, and/or dry-laid processes. Insulation or sound absorption layers may also be bonded to one or more surfaces of the articles described herein, and the insulation or sound absorption layers may be open or closed, e.g., an open cell foam or a closed cell foam, as desired.

In certain embodiments, the LWRT articles described herein can be molded to a specific thickness. While not necessarily true in all cases, the molding temperature can be selected to increase the overall volume of the lofting agent, which can increase the thickness of the LWRT article. LWRT articles without a lofting agent can also be lofted to some degree during molding if they are compressed during formation of the LWRT article. The exact molding thickness may vary as desired, and typical molding thicknesses vary from about 1 cm to about 10 cm in the machine and cross directions though other molding thickness can also be used.

In certain embodiments, as noted herein, the presence of the bicomponent fibers, reinforcing fibers, lofting agent and thermoplastic material in the core layer of the LWRT articles can provide improved mechanical properties for a selected molding thickness.

In certain embodiments, an LWRT article comprising a core layer and a skin layer may comprise peak load values of about 10 N/cm to about 40 N/cm in the machine direction and about 5 N/cm to about 30 N/cm in the cross direction as measured by SAEJ949_200904 at a molding thickness from 1.5 cm to 4 cm in the machine and cross directions.

In certain embodiments, an LWRT article comprising a core layer and a skin layer may comprise stiffness values of about 6 N/cm to about 50 N/cm in the machine direction and about 3 N/cm to about 30 N/cm in the cross direction as measured by SAEJ949_200904 at a molding thickness from 1.5 cm to 4 cm in the machine and cross directions.

In certain embodiments, an LWRT article comprising a core layer and a skin layer may comprise flexural strength values of about 6 N/m² to about 20 N/m² in the machine direction and about 4 N/m² to about 12 N/m² in the cross direction as measured by SAEJ949_200904 at a molding thickness from 1.5 cm to 4 cm in the machine and cross directions.

In some examples, an LWRT article comprising a core layer and a skin layer may comprise flexural modulus of about 800 N/m² to about 1800 N/m² in the machine direction and about 500 N/m² to about 1600 N/m² in the cross direction as measured by SAEJ949_200904 at a molding thickness from 1.5 cm to 4 cm in the machine and cross directions.

In certain embodiments, the core layers and articles described herein can be used in building and automotive applications such as, for example, headliners, rear window trims, trunk trims, office partition panels, cabinet back panels, interior automotive panels or other interior automotive articles.

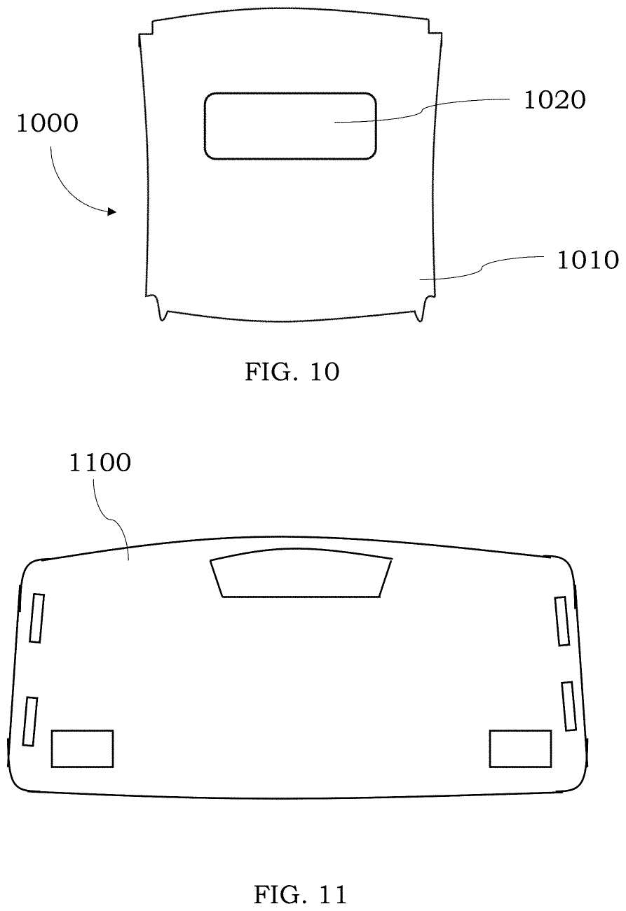

In certain embodiments and referring to FIG. 10, the articles described herein can be present in a headliner of a vehicle. Illustrative vehicles include, but are not limited to, automotive vehicles, trucks, trains, subways, recreational vehicles, aircraft, ships, submarines, space craft and other vehicles which can transport humans or cargo. In some instances, the headliner typically comprises at least one prepreg or core layer comprising bicomponent fibers, reinforcing fibers, a thermoplastic material, lofting agent, one or more optional skin layers and a decorative layer, e.g., a decorative fabric, disposed on the core layer or on a skin layer. The decorative layer, in addition to being aesthetically and/or visually pleasing, can also enhance sound absorption and may optionally include foam, insulation or other materials. An illustration of a top view of a headliner is shown in FIG. 10. The headliner 1000 comprises a body 1010 and an opening 1020, e.g., for a sunroof, moonroof, etc. The body of the headliner 1010 can be produced using one or more of the core layers described herein, and using a molding machine where the decorative fabric is placed onto a surface of the core layer and pressed with the desired mold to convert the article into a headliner with a desired shape. The opening 1020 may then be provided by trimming the headliner 1000. The non-visible surface of the headliner, e.g., the surface which rests against the roof of the vehicle, may comprise one or more additional layers or an adhesive as desired. The overall shape and geometry of the headliner may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle. In some examples, the core layer of the headliner 1000 may comprise 20% to 80% by weight reinforcing fibers and bicomponent fibers (collectively) and 20% to 80% by weight thermoplastic material. In other embodiments, the reinforcing fibers comprise glass fibers and the thermoplastic material comprises a polyolefin. The bicomponent fibers may comprise a core-shell arrangement or other arrangements as described herein. In some examples, the automotive headliner may provide peak load values, stiffness values, flexural strength values and/or flexural modulus values as discussed herein in connection with the core layer.

In certain instances, core layers can also be used to produce other automotive interior components including panels, trim pieces and the like. An illustration of a rear window trim 1100 (top view) is shown in FIG. 11. The trim 1100 may comprise one or more of the core layers as described herein optionally with a skin layer and/or a decorative layer. In some examples, the core layer of the automotive components such as trim pieces may comprise 20% to 80% by weight reinforcing fibers and bicomponent fibers (collectively) and 20% to 80% by weight thermoplastic material. In other embodiments, the reinforcing fibers comprise glass fibers and the thermoplastic material comprises a polyolefin. The bicomponent fibers may comprise a core-shell arrangement or other arrangements as described herein. In some examples, the automotive trim or interior components may provide peak load values, stiffness values, flexural strength values and/or flexural modulus values as discussed herein in connection with the core layer.

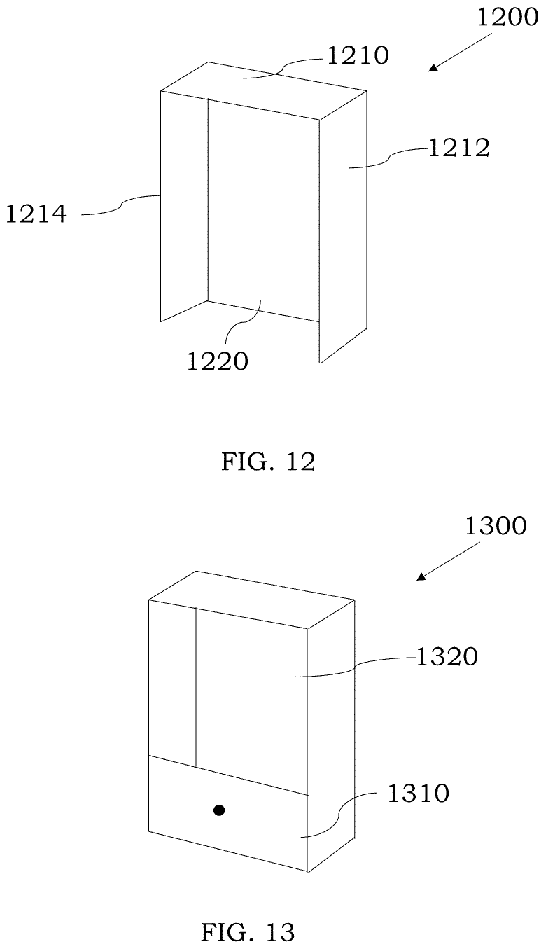

In other configurations, the bicomponent fibers described herein can be used in non-automotive articles such as furniture. For example and referring to FIG. 12, a display cabinet 1200 is shown that comprises a top surface 1110, side surfaces 1212, 1214 coupled to the front surface 1210 and a back surface 1220 coupled to the side surfaces 1212, 1214. The surfaces 1210, 1212, 1214, and 1220 together form a user accessible interior storage area. While not shown the cabinet 1200 may comprise a front surface, e.g., a glass surface or other materials to view the contents of the cabinet. Alternatively, a door or other device can be attached to the cabinet 1200 to shield the contents within the cabinet 1200 from view. One or more surfaces of the cabinet 1200 may be configured as a LWRT article with a core layer comprising TP material, reinforcing fibers and bicomponent fibers. In some examples, the back surface 1220 may comprise a core layer comprising a web of reinforcing fibers and bicomponent fibers held together by a thermoplastic material. Where more than one of the surfaces of the article 1200 comprises bicomponent fibers in a layer, the layers need not have the same composition, thickness or number of layers. In some examples, the core layer of the furniture article 1200 may comprise 20% to 80% by weight reinforcing fibers and bicomponent fibers (collectively) and 20% to 80% by weight thermoplastic material. In other embodiments, the reinforcing fibers comprise glass fibers and the thermoplastic material comprises a polyolefin. The bicomponent fibers may comprise a core-shell arrangement or other arrangements. In some examples, the furniture article 1200, or a panel thereof, may provide peak load values, stiffness values, flexural strength values and/or flexural modulus values as discussed herein in connection with the core layer.

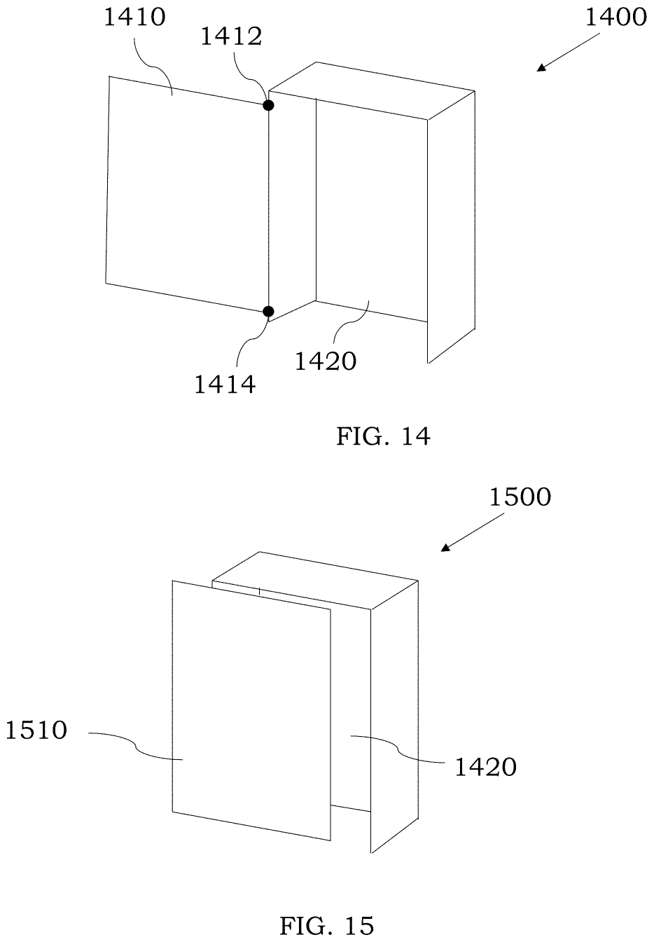

In some configurations, the furniture article can be configured to receive at least one drawer. For example and referring to FIG. 13, a cabinet 1300 is shown as comprising a drawer 1310 and a back surface 1320. The back surface 1320, for example, may comprise a LWRT article as described herein, e.g., one with bicomponent fibers. Other surfaces of the cabinet 1300 may also comprise a LWRT article as described herein. In other configurations, the furniture article 1300 can be configured to receive (or may comprise) at least one door. Referring to FIG. 14, a cabinet 1400 comprises a door 1410 and a back surface 1420. The back surface 1420, for example, may comprise a LWRT article as described herein. Other surfaces of the cabinet 1400 may also comprise a LWRT article described herein. If desired, an outer surface of the door 1410 may comprise a LWRT as described herein. Where the cabinet comprises a door, the door need not be a closable by way of a hinges 1412, 1414. Instead, the door could be configured as a sliding door 1510 as shown in the cabinet 1500 of FIG. 15.

Certain specific examples are described to illustrate further some of the aspects of the technology described herein.

### EXAMPLE 1

Several samples were prepared and tested to determine the properties of composite articles that included the bicomponent fibers. The materials used in the tested samples and their numbering are shown in Table 1 below. PP refers to polypropylene. The polymeric fibers that were tested were core-shell bicomponent fibers with LLDPE in the shell and polyethylene terephthalate in the core.

TABLE 1

| | Core | | | | | | |
|---|---|---|---|---|---|---|---|
| | basis | | | Poly- | Micro- | | |
| | weight | | Glass | meric | sphere | | |
| ST # | gsm | PP % | % | fiber % | % | Film | Scrim |
| ST- | 900 | 45 | 40 | 15 | 0 | 70 gsm | 20 gsm |
| 12242 | | | | | | adhesive | scrim |
| | | | | | | film | |
| ST- | 700 | 45 | 40 | 15 | 0 | 70 gsm | 20 gsm |
| 12243 | | | | | | adhesive | scrim |
| | | | | | | film | |
| ST- | 900 | 44.1 | 39.2 | 14.7 | 2 | 70 gsm | 20 gsm |
| 12244 | | | | | | adhesive | scrim |
| | | | | | | film | |
| ST- | 700 | 44.1 | 39.2 | 14.7 | 2 | 70 gsm | 20 gsm |
| 12245 | | | | | | adhesive | scrim |
| | | | | | | film | |

### EXAMPLE 2

The composite articles of Example 1 were molded to different thicknesses. Table 2 below lists some of the different thickness for the different articles. MD refers to the longitude direction of the tested specimen matches the machine direction, and CD refers to that the longitude direction of the tested specimen matches the cross-machine direction.

TABLE 2

Molding Thickness (cm)

| ST Number | MD | CD |
|---|---|---|
| ST-12242a | 2.1 | 2.1 |
| ST-12242b | 2.6 | 2.6 |
| ST-12242c | 3.0 | 3.1 |
| ST-12242d | 3.3 | 3.4 |
| ST-12243a | 1.6 | 1.4 |
| ST-12243b | 1.8 | 1.9 |
| ST-12243c | 2.5 | 2.5 |
| ST-12244a | 2.5 | 2.5 |
| ST-12244b | 3.0 | 3.1 |
| ST-12244c | 3.5 | 3.6 |
| ST-12244d | 4.0 | 4.0 |
| ST-12245a | 2.0 | 2.0 |
| ST-12245b | 2.6 | 2.5 |
| ST-12245c | 3.2 | 3.1 |

### EXAMPLE 3

Peak load values of the test samples were measured using SAEJ949_200904. A three point bending test was used with the film side of the test samples facing the load in the three point bending test. The measured peak load values for the tested samples is shown in Table 3 below.

TABLE 3

| | | Peak Load | | |
|---|---|---|---|---|
| | | (Newtons) | | |
| ST Number | MD | STD. DEV. | CD | STD. DEV. |
| ST-12242a | 22.5 | 1.7 | 14.4 | 0.8 |
| ST-12242b | 25.2 | 2.0 | 17.0 | 0.8 |
| ST-12242c | 28.5 | 2.8 | 17.3 | 1.2 |
| ST-12242d | 33.2 | 3.6 | 21.3 | 1.0 |
| ST-12243a | 11.9 | 1.1 | 6.2 | 0.6 |
| ST-12243b | 13.5 | 0.9 | 8.7 | 1.5 |
| ST-12243c | 17.6 | 1.7 | 13.2 | 1.2 |
| ST-12244a | 32.2 | 1.2 | 21.1 | 1.6 |
| ST-12244b | 30.5 | 2.2 | 20.0 | 1.5 |
| ST-12244c | 35.3 | 2.1 | 22.4 | 1.0 |
| ST-12244d | 36.5 | 1.7 | 26.6 | 2.4 |
| ST-12245a | 18.5 | 1.8 | 12.8 | 0.6 |
| ST-12245b | 20.1 | 2.2 | 14.2 | 1.2 |
| ST-12245c | 20.0 | 2.0 | 14.3 | 2.6 |

For all the tested samples, as molding thickness increases, the peak load values in the machine and cross directions generally increase. In comparing the peak load values of samples with microspheres (ST-12244 and ST-12245) to those samples without microspheres (ST-12242 and ST-12243), peak load is generally higher for microsphere based samples at a similar thickness. For example, at 2.6 cm thickness, the 990 gsm ST-12242b sample had peak load values of 25.2 and 17.0 in the machine direction and cross-directions respectively. At 2.5 cm thickness, the 990 gsm ST-12244a sample had peak load values of 32.2 and 21.1 in the machine direction and cross-directions, respectively. A similar result is observed for the 790 gsm samples where, for example, the MD and CD peak load values of ST-12245a are larger than the MD and CD peak load values for ST-12243c. These results are consistent with the combination of thermoplastic material, reinforcing fibers, polymeric fibers and microspheres providing improved peak loads at a selected basis weight and molding thickness.

### EXAMPLE 4

Stiffness values of the test samples were measured using SAEJ949_200904. A three point bending test was used with the film side of the test samples facing the load in the three point bending test. The measured stiffness values for the tested samples is shown in Table 4 below.

TABLE 4

| | | Stiffness (N/cm) | | |
|---|---|---|---|---|
| ST Number | MD | STD. DEV. | CD | STD. DEV. |
| ST-12242a | 13.3 | 1.1 | 10.0 | 0.4 |
| ST-12242b | 21.0 | 1.1 | 17.3 | 1.8 |
| ST-12242c | 27.6 | 1.7 | 21.3 | 1.7 |
| ST-12242d | 37.5 | 1.4 | 26.2 | 3.2 |
| ST-12243a | 6.4 | 1.1 | 3.4 | 0.3 |
| ST-12243b | 8.0 | 0.9 | 6.0 | 1.2 |
| ST-12243c | 15.1 | 1.4 | 12.7 | 1.1 |
| ST-12244a | 22.2 | 1.0 | 14.7 | 1.2 |
| ST-12244b | 27.4 | 1.8 | 16.3 | 2.2 |
| ST-12244c | 36.0 | 3.1 | 23.3 | 1.8 |
| ST-12244d | 45.7 | 1.8 | 29.8 | 2.4 |
| ST-12245a | 10.1 | 1.1 | 7.6 | 0.3 |
| ST-12245b | 15.2 | 1.0 | 11.5 | 0.9 |
| ST-12245c | 22.2 | 1.7 | 14.3 | 1.9 |

Stiffness was generally lower with the lighter articles that included less fibers. In comparing the stiffness values of samples with microspheres (ST-12244 and ST-12245) to those samples without microspheres (ST-12242 and ST-12243), stiffness is the same or higher for microsphere based samples at a similar thickness. For example, at about 2.6 cm molding thickness, the 990 gsm ST-12242b sample had stiffness value of 21.0 in the machine direction. At 2.5 cm molding thickness, the 990 gsm ST-12244a sample had a stiffness value of 22.2. For these same samples, stiffness in the cross-direction decreased in the presence of the microspheres. For the 790 gsm samples, the MD and CD stiffness values (10.1 and 7.6) of ST-12245a are less than the MD and CD stiffness values (15.1 and 12.7) for ST-12243c. These results are consistent with the bicomponent fibers and microspheres providing the same or a more flexible article than results in the absence of the microspheres.

### EXAMPLE 5

Flexural strength values of the test samples were measured using SAEJ949_200904. A three point bending test was used with the film side of the test samples facing the load in the three point bending test. The measured flexural strength values for the tested samples is shown in Table 5 below.

TABLE 5

| | | Flexural | | |
|---|---|---|---|---|
| | | Strength (MPa) | | |
| ST Number | MD | STD. DEV. | CD | STD. DEV. |
| ST-12242a | 15.9 | 1.1 | 9.5 | 0.6 |
| ST-12242b | 11.3 | 1.0 | 7.4 | 0.8 |
| ST-12242c | 9.4 | 1.3 | 5.5 | 0.4 |
| ST-12242d | 9.3 | 1.5 | 5.6 | 0.5 |
| ST-12243a | 14.1 | 1.5 | 10.2 | 1.0 |
| ST-12243b | 12.8 | 1.8 | 7.6 | 1.6 |
| ST-12243c | 8.9 | 1.8 | 6.3 | 0.3 |
| ST-12244a | 15.1 | 0.8 | 9.9 | 0.9 |
| ST-12244b | 10.0 | 1.1 | 6.5 | 0.5 |
| ST-12244c | 8.9 | 0.9 | 5.3 | 0.4 |
| ST-12244d | 6.8 | 0.4 | 5.2 | 0.6 |
| ST-12245a | 14.5 | 0.9 | 10.2 | 0.5 |
| ST-12245b | 9.2 | 0.9 | 6.9 | 0.5 |
| ST-12245c | 6.1 | 0.4 | 4.5 | 0.9 |

Flexural strength generally decreased with increased molding thickness. Flexural strength was also generally lower with the lighter articles that included less fibers. In comparing the flexural strength of samples with microspheres (ST-12244 and ST-12245) to those samples without microspheres (ST-12242 and ST-12243), flexural strength is the same or higher for microsphere based samples at a similar thickness. For example, at about 2.6 cm molding thickness, the 990 gsm ST-12242b sample had a flexural strength of 11.3 in the machine direction. At 2.5 cm molding thickness, the 990 gsm ST-12244a sample had a flexural strength of 15.1. For these same samples, flexural strength in the cross-direction increased slightly in the presence of the microspheres. For the 790 gsm samples, the MD and CD flexural strength values (14.5 and 10.2) of ST-12245a were much higher than the MD and CD flexural strength values (8.9 and 6.3) for ST-12243c. These results are consistent with the bicomponent fibers and microspheres providing the same or better flexural strength.

### EXAMPLE 6

Flexural modulus values of the test samples were measured using SAEJ949_200904. A three point bending test was used with the film side of the test samples facing the load in the three point bending test. The measured flexural modulus values for the tested samples is shown in Table 6 below.

TABLE 6

| | | Flexural | | |
|---|---|---|---|---|
| | | Modulus (MPa) | | |
| ST Number | MD | STD. DEV. | CD | STD. DEV. |
| ST-12242a | 1742.3 | 91.3 | 1199.8 | 56.9 |
| ST-12242b | 1389.3 | 26.8 | 1108.0 | 190.6 |
| ST-12242c | 1154.7 | 159.2 | 839.3 | 78.3 |
| ST-12242d | 1228.7 | 247.8 | 789.5 | 120.4 |
| ST-12243a | 1796.8 | 159.7 | 1577.7 | 132.6 |
| ST-12243b | 1603.8 | 192.2 | 1096.8 | 278.2 |
| ST-12243c | 1195.5 | 265.8 | 914.3 | 40.5 |
| ST-12244a | 1582.8 | 118.7 | 1048.8 | 105.3 |
| ST-12244b | 1136.7 | 138.6 | 660.2 | 89.5 |
| ST-12244c | 1003.8 | 66.0 | 587.5 | 75.1 |
| ST-12244d | 819.0 | 24.3 | 562.5 | 60.4 |
| ST-12245a | 1546.7 | 100.5 | 1204.8 | 85.0 |
| ST-12245b | 1048.8 | 56.3 | 867.5 | 64.7 |
| ST-12245c | 816.3 | 66.6 | 546.8 | 80.1 |

Flexural modulus strength generally decreased with increased molding thickness. In comparing the flexural modulus of samples with microspheres (ST-12244 and ST-12245) to those samples without microspheres (ST-12242 and ST-12243), flexural modulus is the same or higher for microsphere based samples at a similar thickness. For example, at about 2.6 cm molding thickness, the 990 gsm ST-12242b sample had a flexural modulus of 1389.6 in the machine direction. At 2.5 cm molding thickness, the 990 gsm ST-12244a sample had a flexural modulus of 1582.8. For these same samples, flexural strength in the cross-direction increased in the presence of the microspheres. For the 790 gsm samples, the MD and CD flexural modulus values (1546.7 and 1204.8) of ST-12245a were much higher than the MD and CD flexural modulus values (1195.5 and 914.3) for ST-12243c. These results are consistent with the bicomponent fibers and microspheres providing the same or better flexural modulus.

### EXAMPLE 7

The glass/bi-component polymeric fiber hybrid LWRT (H-LWRT) and the standard glass fiber LWRT (S-LWRT) sheets were manufactured by using a same wet-laid process. Polyolefin resin, chopped glass fiber, and bi-component polymeric fiber for H-LWRT were dispersed in water. The aqueous suspension of well dispersed resin and fiber was transferred onto a web-forming section and expanding agents were added to the continuous web. The resulting web was drained, heated, laminated with surface materials (scrim and film) and consolidated to produce flat LWRT composite sheets. Materials with various basis weight (areal densities) can be produced by adjusting the manufacturing parameters. The control sample (S-LWRT) had a basis weight of 650 g/m2, which is about 14.4% heavier than the HLWRT's basis weight of 568 g/m2.

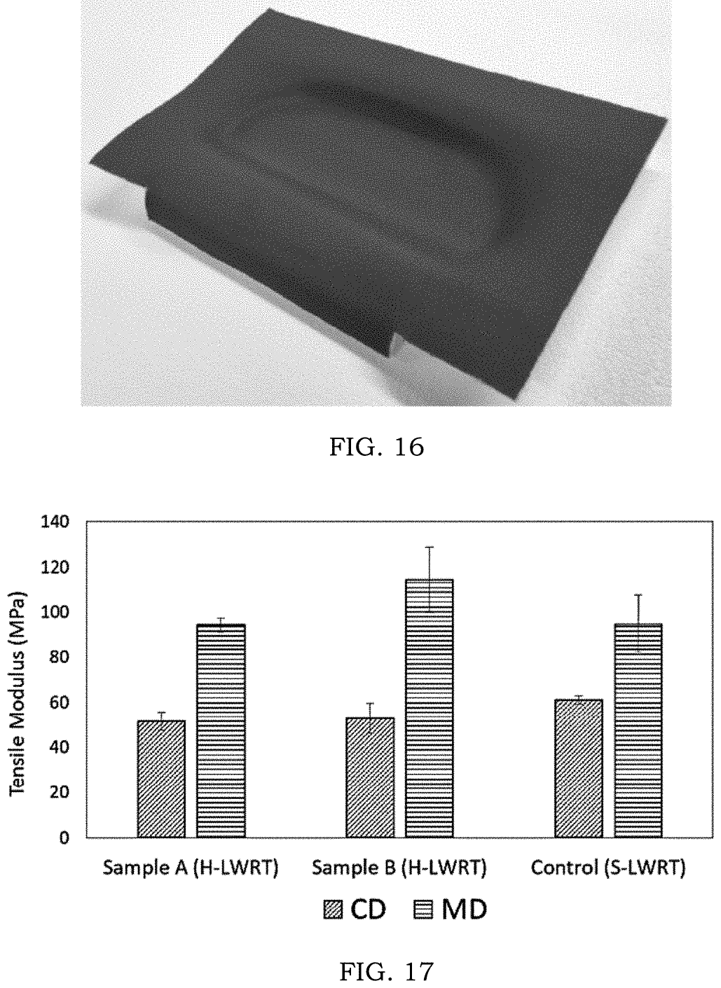

After being heated above the melting point of the resin, the materials experience thickness increase due to the release of residual stress from bent fibers, as well as from the expanding/lofting agent. Therefore, all materials are capable of being molded into thicknesses of 3.5 to 7 mm, which are thicker than the as-produced status/thicknesses (Table 1). FIG. 16 shows an example part which is molded from a sample B (H-LWRT) sheet. The material shows good formability to adapt to complicated shapes in a mold.

Analytical properties including basis weight (areal density), as-produced thickness, and glass (ash) content were measured following standard internal testing procedure. The tensile properties of samples with thickness of 3 mm were measured according to ASTM D790. The flexural properties of the molded specimens with thicknesses of 3.5, 4, 5.5 and 7 mm, were evaluated according to ASTM D638. Table 7 shows the physical properties of the S-LWRT and H-LWRT.

TABLE 7

| Sample | Basis Weight (g/m²) | Thickness (mm) | Ash (%) |
|---|---|---|---|
| Control (S-LWRT) | 650 | 1.02 | 33.50 |
| Sample A (H-LWRT) | 568 | 1.12 | 29.72 |
| Sample B (H-LWRT) | 568 | 1.20 | 34.18 |

The control sample S-LWRT was 82 g/m² (14.4%) heavier than the two H-LWRT samples. The S-LWRT shows a slightly lower thickness, indicating a slightly higher consolidation level. Samples A and B (H-LWRT) have different glass contents, due to the different weight percentages of bi-component polymeric fiber.

### EXAMPLE 8

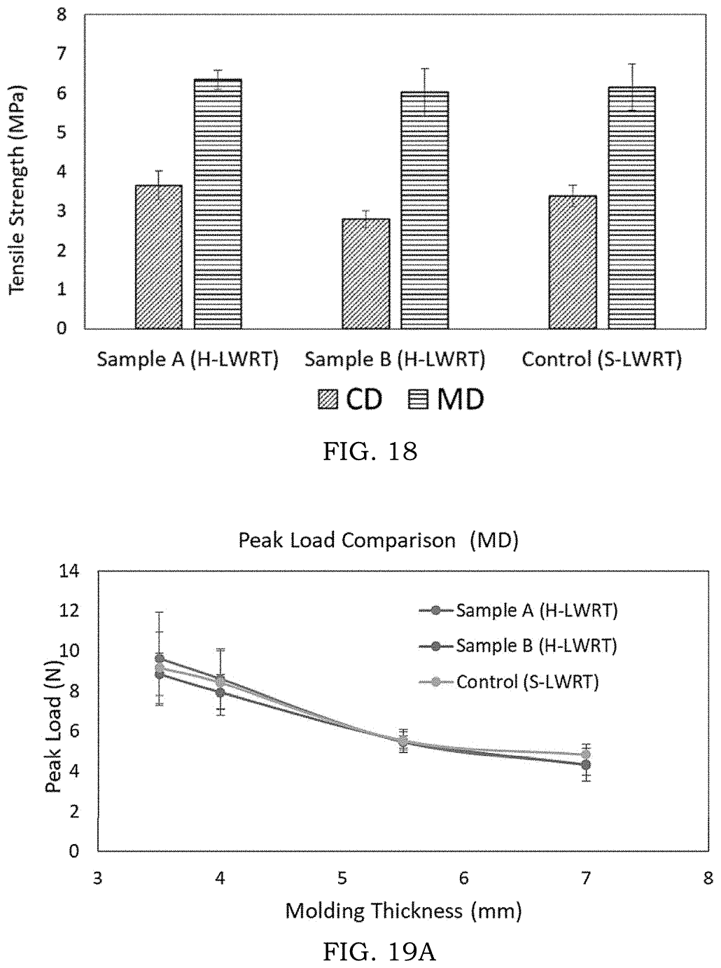

To evaluate the tensile properties of the samples shown in Table 7, molded plaques with a thickness of 3.5 mm were cut into dog-bone tensile specimens by a punch press. FIG. 17 is a graph showing the tensile modulus, and FIG. 18 is a graph showing the tensile strength of sample A (H-LWRT), sample B (H-LWRT), and the control (S-LWRT). For both tensile modulus and tensile strength, all three samples show significantly better results in a machine direction (MD) than those in a cross-machine direction (CD). This may be due to the fiber orientation biases favoring the machine direction, which primarily occurs in the headbox. The flow in the head-box is a mix of both shearing and extension. The complicated flow can feature shearing close to the walls and stretch toward the machine direction within the entire domain. As a result, the fibers can be strongly aligned toward the flow direction leading to better mechanical performances in MD.

Sample B (H-LWRT) has the best average tensile modulus in MD, while the control (SLWRT) shows only slightly larger average modulus than both sample A and B in CD. For the tensile strength, all three samples show very comparable performances in MD. In CD, sample A shows a similar result to the control, and sample B is only slightly lower than the other two. Notably, the control (S-LWRT) is 82 g/m² heavier than both H-LWRT samples. This means that an up to 82 g/m² weight reduction without sacrificing the tensile properties is achieved by hybridizing glass fiber with bi-component polymeric fiber. Particularly for tensile properties, the strength is highly dependent on the bonding between resin and fibers. The bi-component polymeric fiber has a component with a melting point lower than the matrix resin. During the heating and consolidation stages, the component with the lower melting point in the polymeric fiber melts and bonds to the glass fiber surface, which is considered to contribute to better resin wet-out around glass fibers.

### EXAMPLE 9

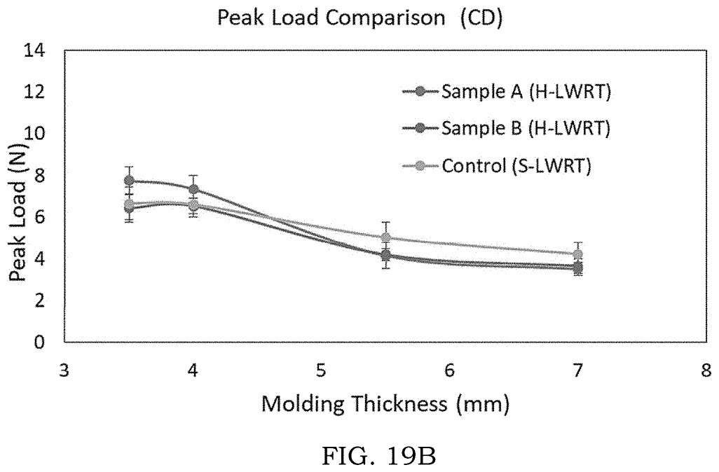

Flexural tests were conducted on specimens molded into 3.5, 4, 5.5 and 7 mm. FIGS. 19A and 19B compare the peak load at both MD and CD between sample A (H-LWRT), sample B (HLWRT) and Control (S-LWRT). Just like the tensile properties, peak load results in the MD are also better than those in CD. The peak load is decreased as the thickness increases, owing to the increase of porosity. Through the entire molding thickness range, all three samples show very comparable peak load results. This indicates that an up to 82 g/m2 weight reduction without sacrificing the flexural peak load is achieved by hybridizing glass fiber with bi-component polymeric fiber.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A molded porous composite article comprising a lofted core layer comprising a web formed from reinforcing fibers, bicomponent fibers, a lofting agent and a thermoplastic material, wherein the web comprises a porosity of about 20% to about 80%, and wherein the bicomponent fibers comprise a core-shell arrangement, wherein a shell material of the shell of the core-shell arrangement comprises a melting point that is substantially similar to a melting point of the thermoplastic material, and wherein a core material of the core of the core-shell arrangement comprises a melting point that is at least twenty degrees Celsius higher than the melting point of the thermoplastic material, and wherein the molded porous composite article comprises a peak load of 10 N to about 40 N in the machine direction and a peak load of about 6N to about 30N in the cross direction at a molded thickness of about 2 mm to about 4 mm in both the machine and cross directions as tested by SAE J949_200904.

2. The molded porous composite article of claim 1, wherein the bicomponent fibers comprise a shell comprising a polyolefin and a core comprising a polyester or a polyamide.

3. The molded porous composite article of claim 2, wherein the bicomponent fibers comprise a shell comprising a polyolefin and a core comprising a polyester.

4. The molded porous composite article of claim 3, wherein the polyolefin comprises a polyethylene.

5. The molded porous composite article of claim 4, wherein the polyethylene is linear low density polyethylene.

6. The molded porous composite article of claim 5, wherein the polyester comprises polyethylene terephthalate.

7. The molded porous composite article of claim 2, wherein the polyamide comprises nylon.

8. The molded porous composite article of claim 2, wherein the thermoplastic material is polypropylene, the polyolefin of the shell comprises linear low density polyethylene, the lofting agent comprises expandable microspheres and the polyester of the core comprises polyethylene terephthalate.

9. The molded porous composite article of claim 2, wherein the thermoplastic material is polypropylene, the polyolefin of the shell comprises linear low density polyethylene, the lofting agent comprises expandable microspheres and the polyamide of the core comprises nylon.

10. The molded porous composite article of claim 1, wherein the thermoplastic material comprises polypropylene, the reinforcing fibers comprise glass fibers, the bicomponent fibers comprise a linear low density polyethylene in the shell and a polyester or polyamide in the core, wherein a melting point of the polyester or polyamide in the core is at least twenty degrees Celsius higher than a melting point of the thermoplastic material, wherein the lofting agent comprises expandable microspheres.

11. The molded porous composite article of claim 10, wherein the molded composite article further comprises a stiffness in the machine direction of about 10 N/cm to about 50 N/cm and a stiffness in the cross direction of about 7 N/cm to about 30 N/cm as tested by SAE J949_200904.

12. The molded porous composite article of claim 10, wherein the molded composite article further comprises a flexural strength in the machine direction of about 6 MPa to about 17 MPa and a flexural strength in the cross direction of about 4 MPa to about 11 MPa as tested by SAE J949_200904.

13. The molded porous composite article of claim 10, wherein the molded composite article further comprises a flexural modulus in the machine direction of about 800 MPa to about 2000 MPa and a flexural modulus in the cross direction of about 500 MPa to about 1300 MPa as tested by SAE J949_200904.

14. The molded porous composite article of claim 10, wherein the molded composite article further comprises a stiffness in the machine direction of about 10 N/cm to about 50 N/cm and a stiffness in the cross direction of about 7 N/cm to about 30 N/cm as tested by SAE J949_200904 and a flexural strength in the machine direction of about 6 MPa to about 17 MPa and a flexural strength in the cross direction of about 4 MPa to about 11 MPa as tested by SAE J949_200904.

15. The molded porous composite article of claim 10, wherein the molded composite article further comprises a stiffness in the machine direction of about 10 N/cm to about 50 N/cm and a stiffness in the cross direction of about 7 N/cm to about 30 N/cm as tested by SAE J949 200904 and a flexural modulus in the machine direction of about 800 MPa to about 2000 MPa and a flexural modulus in the cross direction of about 500 MPa to about 1300 MPa as tested by SAE J949_200904.

16. The molded porous composite article of claim 10, wherein the molded composite article further comprises a flexural strength in the machine direction of about 6 MPa to about 17 MPa and a flexural modulus in the machine direction of about 800 MPa to about 2000 MPa and a flexural modulus in the cross direction of about 500 MPa to about 1300 MPa as tested by SAE J949_200904.

17. The molded porous composite article of claim 10, wherein the molded composite article further comprises a stiffness in the machine direction of about 10 N/cm to about 50 N/cm and a stiffness in the cross direction of about 7 N/cm to about 30 N/cm as tested by SAE J949_200904, a flexural strength in the machine direction of about 6 MPa to about 17 MPa and a flexural strength in the cross direction of about 4 MPa to about 11 MPa as tested by SAE J949_200904, and a flexural modulus in the machine direction of about 800 MPa to about 2000 MPa and a flexural modulus in the cross direction of about 500 MPa to about 1300 MPa as tested by SAE J949_200904.

18. The molded porous composite article of claim 1, wherein the article is configured as an automotive headliner.

19. The molded porous composite article of claim l, wherein the article is configured as an automotive interior component.

20. The molded porous composite article of claim 1, wherein the article is configured as a cubicle panel or a furniture panel.

21-50. (canceled)
